(19) United States
(12) Patent Application Publication
(10) Pub. No.: US 2013/0110862 A1
(43) Pub. Date: May 2, 2013

(54) MAINTAINING A BUFFER STATE IN A DATABASE QUERY ENGINE

(71) Applicants: Qiming Chen, Cupertino, CA (US); Meichun Hsu, Los Altos Hills, CA (US)

(72) Inventors: Qiming Chen, Cupertino, CA (US); Meichun Hsu, Los Altos Hills, CA (US)

(21) Appl. No.: 13/282,870

(22) Filed: Oct. 27, 2011

(51) Int. Cl. G06F 17/30

(52) U.S. Cl. 707/766; 707/E17.14

(57) ABSTRACT

Methods, apparatus and articles of manufacture to maintain a buffer state in a database query engine are disclosed. An example method disclosed herein includes identifying two or more input tuples associated with a query, identifying two or more output tuples associated with the query, associating the input tuples with a query engine input buffer, associating the output tuples with a query engine output buffer, and maintaining a state of the query engine input buffer and the query engine output buffer in response to executing the query in the database query engine to process the input tuples and the output tuples.

### BACKGROUND

Query engines are expected to process one or more queries from data sources containing relatively large amounts of data. For example, nuclear power plants generate terabytes of data every hour that include one or more indications of plant health, efficiency and/or system status. In other examples, space telescopes gather tens of terabytes of data associated with one or more regions of space and/or electromagnetic spectrum information within each of the one or more regions of space. In the event that collected data requires analysis, computations and/or queries, such collected data may be transferred from a storage location to a processing engine. When the transferred data has been analyzed and/or processed, the corresponding results may be transferred back to the original storage location(s).

### BRIEF DESCRIPTION OF THE DRAWINGS

FIG. 1 is a block diagram of a known example query environment.

FIG. 2 is a block diagram of an example query environment including a context unification manager constructed in accordance with the teachings of this disclosure to maintain a buffer state in a database query engine.

FIG. 3 is a block diagram of a portion of the example context unification manager of FIG. 2.

FIG. 4 is an example table indicative of example input tuples and output tuples associated with a query.

FIGS. 5A and 5B are flowcharts representative of example machine readable instructions which may be executed to perform call context unification of query engines and to implement the example query environment of FIG. 2 and/or the example context unification manager of FIGS. 2 and 3.

FIG. 6 is a block diagram of an example system that may execute the example machine readable instructions of FIGS. 5A and/or 5B to implement the example query engine of FIG. 2 and/or the example context unification manager of FIGS. 2 and 3.

### DETAILED DESCRIPTION

The current generation of query engines (e.g., SQL, Oracle, etc.) facilitate system-provided functions such as summation, count, average, sine, cosine and/or aggregation functions. Additionally, the current generation of query engines facilitate general purpose analytic computation into a query pipeline that enable a degree of user customization. Such customized general purpose analytic computation may be realized by way of user defined functions (UDFs) that extend the functionality of a database server. In some examples, a UDF adds computational functionality (e.g., applied mathematics, conversion, etc.) that can be evaluated in query processing statements (e.g., SQL statements). For instance, a UDF may be applied to a data table of temperatures having units of degrees Celsius so that each corresponding value is converted to degrees Fahrenheit.

One or more queries performed by the query engine operate on one or more tables, which may contain multiple input tuples (e.g., rows) in which each tuple may include one or more attributes (e.g., columns). For example, an employee table may include multiple input tables representative of individual employees, and attributes for each tuple may include an employee first name, a last name, a salary, a social security number, an age, a work address, etc. An example query on the table occurs in a tuple-by-tuple manner. For example, a query initiating a UDF to identify a quantity of employees older than a target age, employs a scalar aggregation function (a scalar UDF) tests each tuple for the target age, allocates a buffer to maintain a memory state of all input tuples that participate in the query, and increments and/or otherwise adjusts the buffer state value when the target age for an evaluated tuple matches the target age threshold. The resulting output from this query is a single output tuple, such as an integer value of the quantity of employees identified in the table that, for example, exceed a target threshold age of 35. During the tuple-by-tuple scalar aggregation UDF, the buffer is maintained and incremented until the full set of the input tuples of the query have been processed. Analysis of the complete set of input tuples may be determined via an advancing pointer associated with the input tuple buffer. In other words, for a scalar function, one input (e.g., x and y) generates one output on the input tuples buffered in, for example, a sliding window.

On the other hand, one or more queries performed by the query engine may process a single input tuple and produce two or more output tuples. UDFs that produce two or more output tuples based on an input tuple are referred to herein as table UDFs, in which the query engine allocates a buffer to maintain a memory state of output tuples that correspond to the provided input tuple. An example table function (e.g., a table UDF) may use the input tuple of an employee to generate a first output tuple of an employee last name if such employee is older than the target age threshold, and generate a second output tuple of that employee's corresponding social security number. Unlike a scalar UDF, the query engine executing a table UDF does not maintain and/or otherwise preserve the state of additional input tuples. In other words, in the event one or more additional input tuples reside in the table, the buffer memory allocated by the query engine for a table UDF reflects only output tuples. For a table UDF, one input (e.g., x and y) generates one or more outputs, but such outputs are not buffered. If and/or when the table UDF is called a subsequent time to process another input tuple, any previously stored buffer states are discarded. On the other hand, although the scalar UDF includes an allocated buffer that maintains a state of a number of input tuples during a table query, the scalar UDF does not allocate and/or otherwise provide a buffer to maintain or preserve the state of more than a single output tuple.

Generally speaking, a table UDF can return a set of output tuples, but a scalar UDF and/or an aggregate scalar UDF cannot return more than a single output tuple. Both the table UDFs and the scalar UDFs are bound by attribute values of a single input tuple, but the aggregate scalar function can maintain a running state of input tuples to accommodate running sum operations, sliding windows, etc. A context of a UDF, whether it is a scalar or table UDF, refers to the manner in which the UDF maintains a state of buffered memory within the query engine. When a scalar UDF is called multiple times, the multi call context is associated with the set of input tuples so that repeated initiation and/or reloading of the buffer memory is avoided. The multi call context of a table UDF, on the other hand, is focused on a set of returns (e.g., two or more output tuples), but the table UDF lacks a capability to buffer data across multiple input tuples.

In some examples, a query is desired that includes multiple input tuples and generates multiple output tuples. For instance, a graph represented by a plurality of Cartesian coordinates employs a plurality of input tuples, each representative of one of the graph points. In the event a UDF related to a mathematical process is applied to the input tuples, corresponding output tuples of the resulting graph may be generated. However, the current generation of query engines cannot process table queries that include both multiple input tuples and generate multiple output tuples without first offloading and/or otherwise transferring the input tuples to a non-native application. In other words, known query engines cannot accommodate buffer memory states for a query that maintains both multiple input tuples and multiple output tuples. To accomplish one or more calculations of the aforementioned example graph, the input tuples are transferred to one or more applications (e.g., processors, computers, application specific appliances, etc.) external to the query engine, the input tuples are processed by the external application, and the corresponding results may then be returned to the query engine for storage, display, further processing, etc.

For relatively small data sets of input tuples, exporting and/or otherwise transferring input tuple data from the query engine to one or more external processing application(s) may occur without substantial data congestion and/or network strain. However, for example industries and/or applications that generate and/or process relatively large quantities of data (e.g., nuclear power plants, space telescope research, medical protein folding research, etc.), exporting and/or otherwise transferring data from the native query engine data storage to one or more external applications may be time consuming, computationally intensive and/or burdensome to one or more network(s) (e.g., intranets, the Internet, etc.). Additionally, efforts to transfer large data sets become exacerbated as the distance between the query engine and the one or more external processors increases.

Example methods, apparatus and/or articles of manufacture disclosed herein maintain a buffer state in a database query engine, and/or otherwise unify one or more call contexts of query engines, to reduce (e.g., minimize and/or eliminate) external transfer of input tuples from the query engine. The unified UDFs disclosed herein buffer input tuples (e.g., as a scalar UDF) and, for each one input (e.g., x and y), one or more outputs may be generated. Rather than transferring input tuples associated with queries that require both multiple input tuples and multiple output tuples, example methods, apparatus and/or articles of manufacture disclosed herein maintain query computation within the native query engine environment and/or one or more native databases of the query engine. In other words, because the query is pushed to the query engine, one or more input tuple data transfer operations are eliminated, thereby improving query engine performance and reducing (e.g., minimizing) network data congestion.

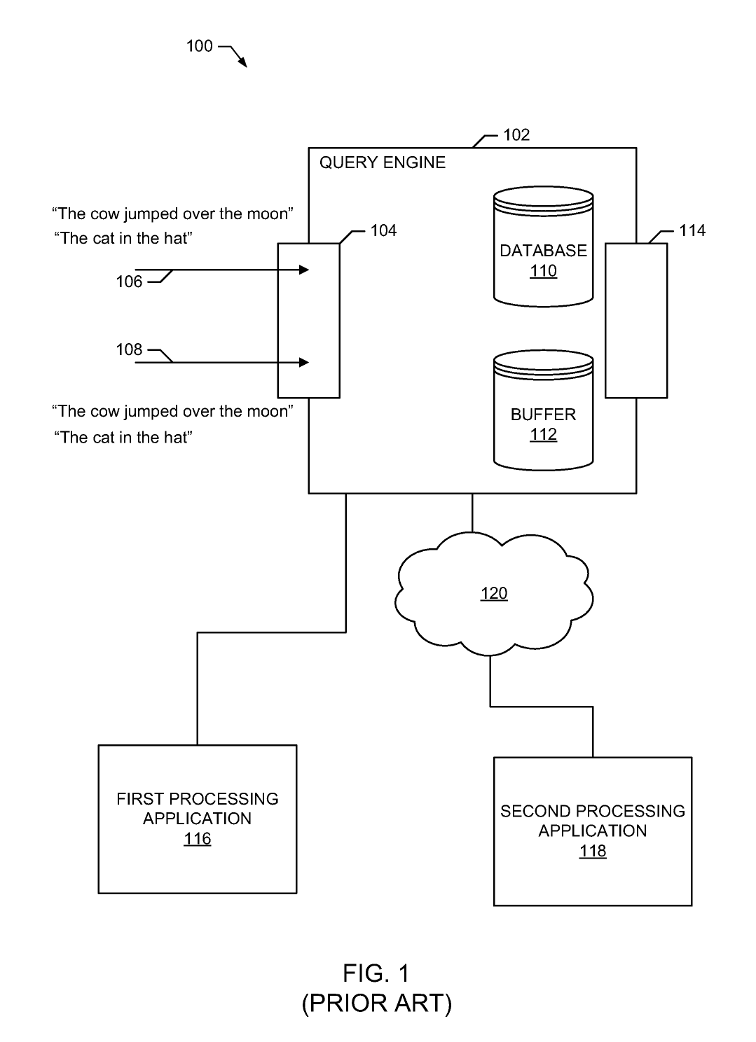

A block diagram of an example known query environment 100 is illustrated in FIG. 1. In the illustrated example of FIG. 1, a query engine 102 includes a query input node 104, which may receive, retrieve and/or otherwise obtain scalar function queries (e.g., a scalar UDF) 106 and/or table function queries (e.g., a table UDF) 108. The example query engine 102 includes a native database 110 and buffers 112 to, in part, manage and/or maintain a memory context during one or more scalar UDF queries or one or more table UDF queries. As used herein, a native database is defined to include one or more databases and/or memory storage entities that contain information so that access to that information does not require one or more network transfer operations and/or bus transfer operations (e.g., universal serial bus (USB), Firewire, etc.) outside the query engine 102. The example query engine 102 of FIG. 1 includes a query output node 114 to provide results from one or more query operations of the example query engine 102.

In operation, when the example query engine 102 of FIG. 1 receives and/or otherwise processes a query operation having a single input tuple and a single output tuple (e.g., a scalar UDF query 106), then the example query engine 102 invokes a memory context associated with that scalar UDF. The memory context associated with the scalar UDF maintains a buffer memory state of the buffers 112 for the input tuple throughout the query operation. In the event that the example scalar UDF is associated with an aggregation (e.g., a sum, an average, etc.), then the memory state of the buffers 112 of the illustrated example is maintained for a plurality of input tuples associated with the query. When the set of input tuples associated with the query have been processed, the example query engine 102 of FIG. 1 generates the query output and releases the buffer state so that one or more subsequent queries may utilize the corresponding portion(s) of the example buffers 112.

In the illustrated example of FIG. 1, the scalar UDF query 106 receives an input tuple containing the phrase “The cow jumped over the moon.” An example scalar UDF query may return an integer value at the query output 114 indicative of the number of words from the input tuple. In such an example, the example query engine 102 generates a value “6” at the example query output 114 (i.e., a single output tuple) to indicate that the input tuple includes six words. In the event a subsequent input tuple is to be processed by the example query engine 102, such as a second input tuple containing the phrase “The cat in the hat,” then an aggregation scalar UDF maintains a memory context to store a running sum of words during processing of all input tuples from the query. The aforementioned example scalar UDF sums the number of individual words from the input tuples such that the example query engine 102 generates a value “11” after processing the second input tuple to represent a total of eleven words corresponding to both input tuples of the query.

On the other hand, when the query engine 102 receives and/or otherwise processes a query operation having a single input tuple and a plurality of output tuples, such as a table UDF query 108, then the example query engine 102 of FIG. 1 invokes a memory context associated with table functions. As described above, the memory context associated with the table UDF maintains a buffer memory state of the buffers 112 that is associated with only a single input tuple, but may generate multiple output tuples. After the input tuple has been processed and the output is generated, then the table function relinquishes the corresponding portion(s) of the buffer so that subsequent query process(es) may utilize those portion(s) of the buffers 112.

In the illustrated example of FIG. 1, the table function query 108 receives an input tuple containing the phrase “The cow jumped over the moon.” An example table UDF query returns individual output tuples, each containing one of the words from the input tuple. In operation, the example query engine 102 generates six output tuples, a first containing the word “The,” the second containing the word “cow,” the third containing the word “jumped,” the fourth containing the word “over,” the fifth containing the word “the,” and the sixth containing the word “moon.” After the input tuple has been processed and the six output tuples are generated, then the table UDF relinquishes the corresponding portion(s) of the buffer. In other words, the buffer state is released.

In the aforementioned example queries, a scalar UDF or a table UDF was individually applied as the basis for the query performed by the example query engine 102. In the event that a query to be performed by the example query engine 102 of FIG. 1 included both multiple input tuples and multiple output tuples, the example query engine 102 transfers the associated query data to one or more external processing applications, such as a first processing application 116 and/or a second processing application 118. For example, if the query includes two input tuples (e.g., Tuple #1 “The cow jumped over the moon” and Tuple #2 “The cat in the hat”), and the query instructions request a total number of words (e.g., a first output tuple having an integer value) and a list of all words from the input tuples (eleven separate tuples, each with a corresponding one of the words from the input tuples), then conventional query engines do not facilitate a memory/buffer context that keeps the state of multiple input tuples and multiple output tuples. Instead, conventional query engines, such as the query engine 102 of FIG. 1, transfer the input tuple data and/or processing directives to one or more external processing application(s).

In the illustrated example of FIG. 1, the first processing application 116 is communicatively connected to the query engine 102, and the second processing application 118 is communicatively connected to the query engine 102 via a network 120 (e.g., an intranet, the Internet, etc.). Both the first processing application 116 and the second processing application 118 are external to the example query engine 102 such that their operation requires a transfer of data from the example native database 110. As described above, in the event that the transfer of data from the example native database 110 is relatively large, the example query engine 102 will allocate computationally intensive processor resources to facilitate the data transfer. As a result, the corresponding network(s) 120 and/or direct-connected bus (e.g., universal serial bus (USB), Firewire, Ethernet, Wifi, etc.) may be inundated with relatively large amounts of information, thereby causing congestion.

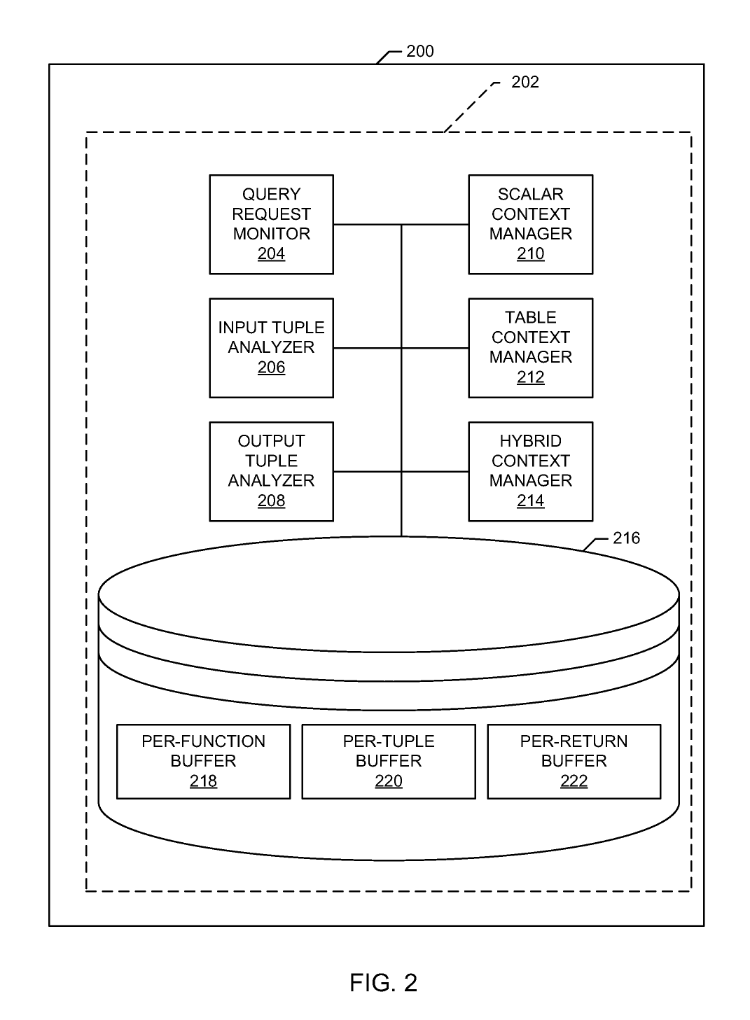

Example methods, apparatus and/or articles of manufacture disclosed herein unify the call contexts of query engines to allow a hybrid query to be processed that includes both a scalar and a table function (e.g., UDFs), which execute within a same native query engine environment. An advantage of enabling hybrid queries to execute in a native query engine environment includes reducing (e.g., minimizing and/or eliminating) computationally and/or bandwidth intensive data transfers from the query engine to one or more external processing application(s) 116, 118. In the illustrated example of FIG. 2, an example query engine 200 constructed in accordance with the teachings of this disclosure includes a context unification manager 202, a query request monitor 204, an input tuple analyzer 206, an output tuple analyzer 208, a scalar context manager 210, a table context manager 212 and a hybrid context manager 214. The example context unification manager 202 of FIG. 2 also includes one or more buffers 216 to facilitate maintenance of per-function state(s) with an example per-function buffer 218. A per-tuple state(s) with an example per-tuple buffer 220, and/or per-return state(s) with a per-return buffer 222, as described in further detail below.

In operation, the example query request monitor 204 of FIG. 2 monitors for a query request of the example query engine 200. Requests may include native SQL queries and/or customized queries based on a UDF. The example input tuple analyzer 206 of FIG. 2 detects, analyzes and/or otherwise determines whether there is more than one input tuple. If not, the example output tuple analyzer 208 of FIG. 2 detects, analyzes and/or otherwise determines whether the query request includes more than one output tuple. In the event that the query includes a single input tuple and a single output tuple, or multiple input tuples and a single output tuple, then the example scalar context manager 210 of FIG. 2 initiates a scalar memory context to establish a per-function buffer 218 that can be shared, accessed and/or manipulated in one or more subsequent function calls, if needed. The per-function state of this example relates to a manner of function invocation throughout a query for processing multiple chunks of input tuples, and can retain a composite type and/or descriptor of a returned tuple. In some examples, the per-function state holds input data from the tuple(s) to avoid repeatedly initiating or loading the data during chunk-wise processing. In some examples, the per-function state will be sustained throughout the life of the function call and the query instance.

Additionally, the example scalar context manager 210 of FIG. 2 initiates a per-tuple buffer 220 that maintains the information during processing of a single input tuple. A scalar function may include two or more buffer resource types (e.g., the per-function buffer 218 and the per-tuple buffer 220) during query processing. While the example buffers 216 of the illustrated example of FIG. 2 include a per-function buffer 218, a per-tuple buffer 220 and a per-return buffer 222, the example methods, apparatus and/or articles of manufacture disclosed herein are not limited thereto. Without limitation, the example buffers 216 of FIG. 2 may include any number and/or type(s) of buffer segments and/or memory.

In the event that the query includes a single input tuple and multiple output tuples, then the example table context manager 212 of FIG. 2 initiates a table memory context to establish a per-tuple buffer 220 and a per-return buffer 222. The example per-return buffer 222 of FIG. 2 delivers one return tuple. While in some examples a table function (e.g., a table UDF) is applied to every input tuple, it is called one or more times for delivering a set of return tuples based on the desired number of output tuples that result from the query. Conventional query engines do not consider the state across multiple input tuples in a table function, but instead maintain a state across multiple returns that correspond to the single input tuple. In contrast, the table function call of the example of FIG. 2 establishes the per-tuple buffer 220 to share, access and/or manipulate data across multiple calls, and establishes the per-return buffer 222 to retain the output tuple value(s).

In the event that the query includes multiple input tuples and multiple output tuples, then the example hybrid context manager 214 of FIG. 2 initiates a hybrid memory context to establish a per-function buffer 218, a per-tuple buffer 220 and a per-return buffer 222. In other words, the hybrid context manager 214 of FIG. 2 allocates memory to (a) maintain a state for a plurality of input tuples, and (b) maintain a state for a plurality of output tuples that may correspond to each input tuple during the query. Such memory allocation is invoked and/or otherwise generated by the example hybrid context manager 214 of FIG. 2 and is not relinquished after a first of the plurality of input tuples is processed. Instead, the allocated memory generated by the example hybrid context manager 214 persists throughout the duration of the query. In other words, the allocated memory persists until the plurality of input tuples have been processed.

In some examples, the context unification manager 202 is natively integrated within the query engine 200. In other examples, the context unification manager 202 is integrated with a traditional query engine, such as the example query engine 102 of FIG. 1. In the event the example context unification manager 202 is integrated with an existing, legacy and/or traditional query engine, the example context unification manager 202 intercepts one or more processes of its host query engine. For example, if a traditional query engine, such as the query engine 102 of FIG. 1, is configured with the example context unification manager 202, the context unification manager 202 may monitor for one or more query types and allow or intercept memory context configuration operations based on the query type.

In the event of detecting a query having a single input tuple and a single output tuple, the example context unification manager 202 of FIG. 2 allows the query engine to proceed with one or more scalar UDFs (function calls) having a scalar memory context. In the event the context unification manager 202 detects a query having multiple input tuples and a single output tuple, such as a summation operation or a sliding window, the example context unification manager 202 of FIG. 2 allows the query engine to proceed with one or more scalar aggregate UDFs having a scalar aggregate memory context. Additionally, in the event the example context unification manager 202 of FIG. 2 detects a query having a single input tuple and multiple output tuples, the example context unification manager 202 allows the query engine to proceed with a table UDF having a table memory context.

However, in the event of detecting a query having both multiple input tuples and multiple output tuples, the example context unification manager 202 of FIG. 2 intercepts one or more commands and/or attempts by the query engine to transfer the query information and/or input tuples to a first processing application 116 and/or a second processing application 118. After intercepting the one or more memory context configuration attempts by the query engine, the example context unification manager 202 of FIG. 2 establishes a memory context that preserves the input tuple state and the output tuple state during the query.

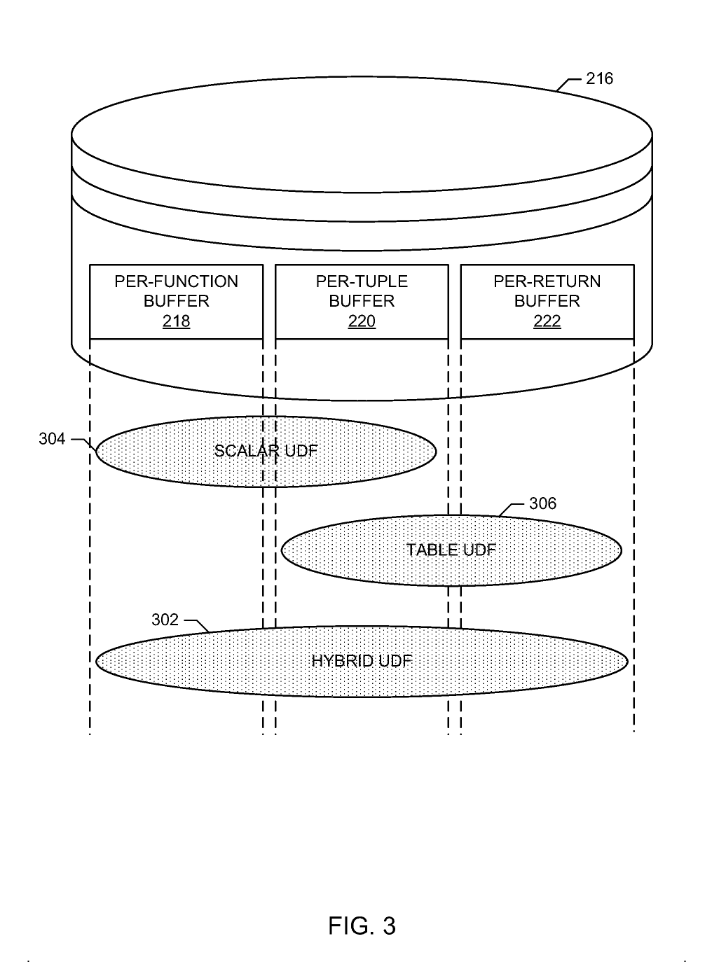

In the illustrated example of FIG. 3, the buffers 216 include the per-function buffers 218, the per-tuple buffers 220 and the per-return buffers 222. A hybrid function, such as a hybrid UDF 302 unifies each of the buffers 218, 220, 222 so that initial data can be loaded and maintained during the query for input tuples, each tuple state may be maintained during each input tuple function call, and a set of multiple output tuples can be generated throughout the query. Unlike the scalar UDFs 304, scalar aggregate UDFs 304 and/or the table UDFs 306 employed by conventional query engines, the example query engine 200 of FIG. 2 establishes a unified context of buffer memory to allow multiple input tuples and multiple output tuples to be processed without transferring tuple information external to the query engine 200. In other words, the hybrid function call facilitates the combined behavior of a scalar function and a table function.

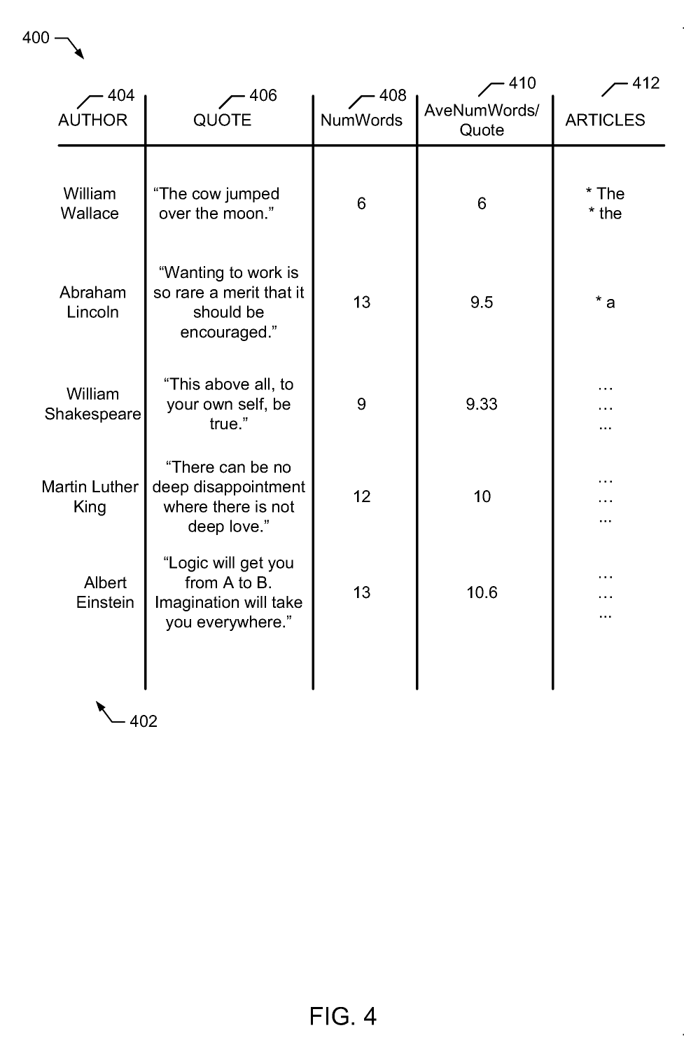

In the illustrated example of FIG. 4, a table 400 includes five input tuples 402, each having an associated author 404 (a first attribute) and a quote 406 (a second attribute). Desired output tuples from an example hybrid query include an output tuple corresponding to a number of words for each quote 408, an output tuple corresponding to a running average of words per quote 410, and an output tuple for each grammatical article contained within each quote 412 (e.g., “a,” “the,” etc.). If a query containing the five input tuples 402 were requested by a conventional query engine, in which multiple output tuples are desired (e.g., a running average of the number of words per sentence and a list of grammatical articles per sentence), then the example query engine 102 would transfer all of the input tuple data to one or more processing applications 116, 118 because it could not accommodate multiple input tuples and multiple output tuples for a query. However, the example query engine 200 of FIG. 2 employs the example context unification manager 202 to invoke and/or otherwise generate a context that unifies the example per-function buffer 218, the example per-tuple buffer 220 and the per-return buffer 222. As described above, the example hybrid context manager 214 invokes the example per-function buffer 218 to maintain a buffer state for the input tuples related to the query, invokes the example per-tuple buffer 220 to maintain a memory state for each of the multiple input tuples during each function call iteration, and invokes the example per-return buffer 222 to maintain a memory state for each of the multiple output tuples. When all of the multiple input tuples have been processed by the requesting query, the example hybrid context manager 214 relinquishes the corresponding portion(s) of the buffers 218, 220, 222 so that they may be available for subsequent native query operations.

Integrating and/or otherwise unifying invocation contexts for scalar and table UDFs may be realized by registering UDFs with the example query engine 200 of FIG. 2. In some such examples, the UDF name, arguments, input mode, return mode and/or dynamic link library (DLL) entry point(s) are registered with the query engine 200. Such registration allows one or more UDF handles to be generated for use by the query engine 200. In the example of FIG. 2, one or more handles for function execution keep track of information about input/output schemas, the input mode(s), the return mode(s), the result set(s), etc. In the example of FIG. 2, execution control of the UDFs occur with an invocation context handle so that the UDF state may be maintained during multiple calls. For example, a scalar UDF is called N times if there are N input tuples, whereas a table UDF is called N×M times if M tuples are to be returned for each input tuple. The generated handle(s) allow buffers of the UDFs to be linked to the query engine calling structure during instances of scalar UDF calls, table UDF calls and/or hybrid scalar/table UDF calls.

In the event of a scalar UDF call in the example of FIG. 2, memory space (e.g., buffers) is initiated at the first instance of a call, and the memory space is pointed to by one or more handles. At the end of the scalar UDF operation on all the input tuples, the memory space of the illustrated example is revoked so that the query engine may use such space for one or more future queries. In the event of a table UDF call in the example of FIG. 2, memory space is initiated when processing each input tuple and revoked after returning the last output value. Conventional table UDFs do not share data that is buffered for processing multiple input tuples in view of one or more subsequent input tuples that may be within the query request. To allow such memory space (buffers) to be maintained and/or otherwise prevent memory space revocation, in the example of FIG. 2, one or more application programming interfaces (APIs) are implemented on the query engine to determine memory states associated with the handle(s), check for instances of a first call, obtain tuple descriptor(s), return output tuple(s) and/or advance pointers to subsequent input tuples in a list of multiple input tuples while keeping memory space available.

While example manners of implementing the query engine 200 and the context unification manager 202 have been illustrated in FIGS. 2-4, one or more of the elements, processes and/or devices illustrated in FIGS. 2-4 may be combined, divided, re-arranged, omitted, eliminated and/or implemented in any other way. Further, the example query engine 200, the example context unification manager 202, the example query request monitor 204, the example input tuple analyzer 206, the example output tuple analyzer 208, the example scalar context manager 210, the example table context manager 212, the example hybrid context manager 214, the example native buffers 216, the example per-function buffer 218, the example per-tuple buffer 220 and/or the example per-return buffer 222 of FIGS. 2-4 may be implemented by hardware, software, firmware and/or any combination of hardware, software and/or firmware. Thus, for example, any of the example query engine 200, the example context unification manager 202, the example query request monitor 204, the example input tuple analyzer 206, the example output tuple analyzer 208, the example scalar context manager 210, the example table context manager 212, the example hybrid context manager 214, the example native buffers 216, the example per-function buffer 218, the example per-tuple buffer 220 and/or the example per-return buffer 222 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus and/or system claims are read to cover a purely software and/or firmware implementation, at least one of the example query engine 200, the example context unification manager 202, the example query request monitor 204, the example input tuple analyzer 206, the example output tuple analyzer 208, the example scalar context manager 210, the example table context manager 212, the example hybrid context manager 214, the example native buffers 216, the example per-function buffer 218, the example per-tuple buffer 220 and/or the example per-return buffer 222 of FIGS. 2-4 are hereby expressly defined to include a tangible computer readable medium such as a physical memory, digital versatile disk (DVD), compact disk (CD), etc., storing such software and/or firmware. Further still, the example query engine 200 and/or the example context unification manager 202 of FIGS. 2-4 may include one or more elements, processes and/or devices in addition to, or instead of, those illustrated in FIGS. 2-4, and/or may include more than one of any or all of the illustrated elements, processes and devices.

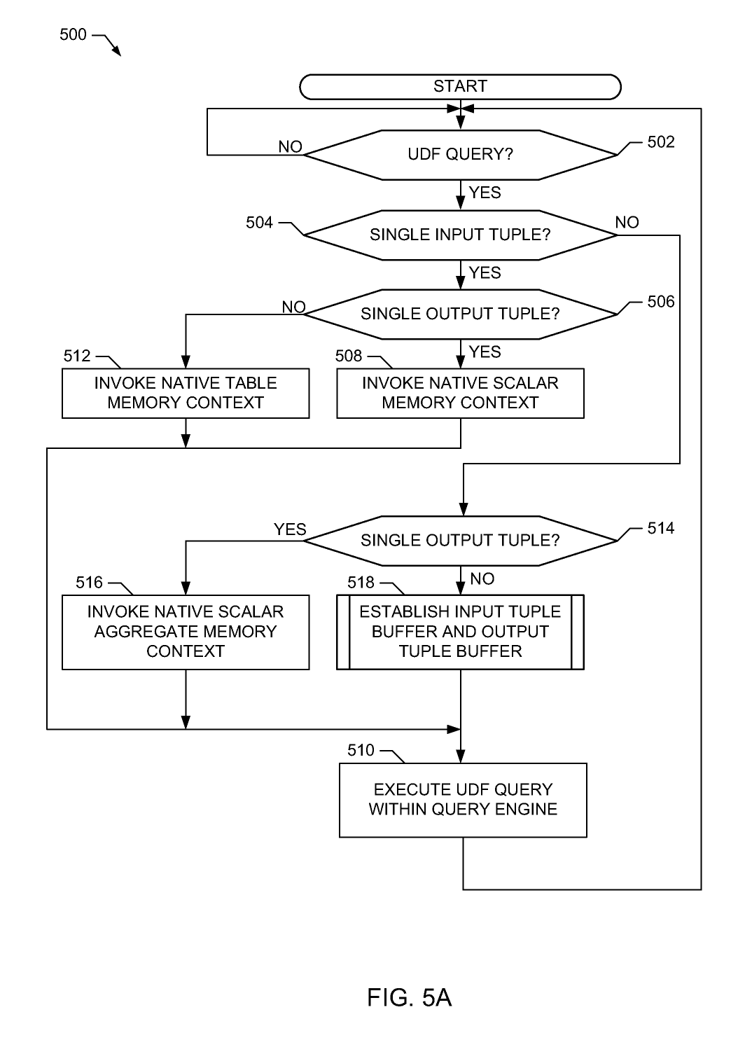

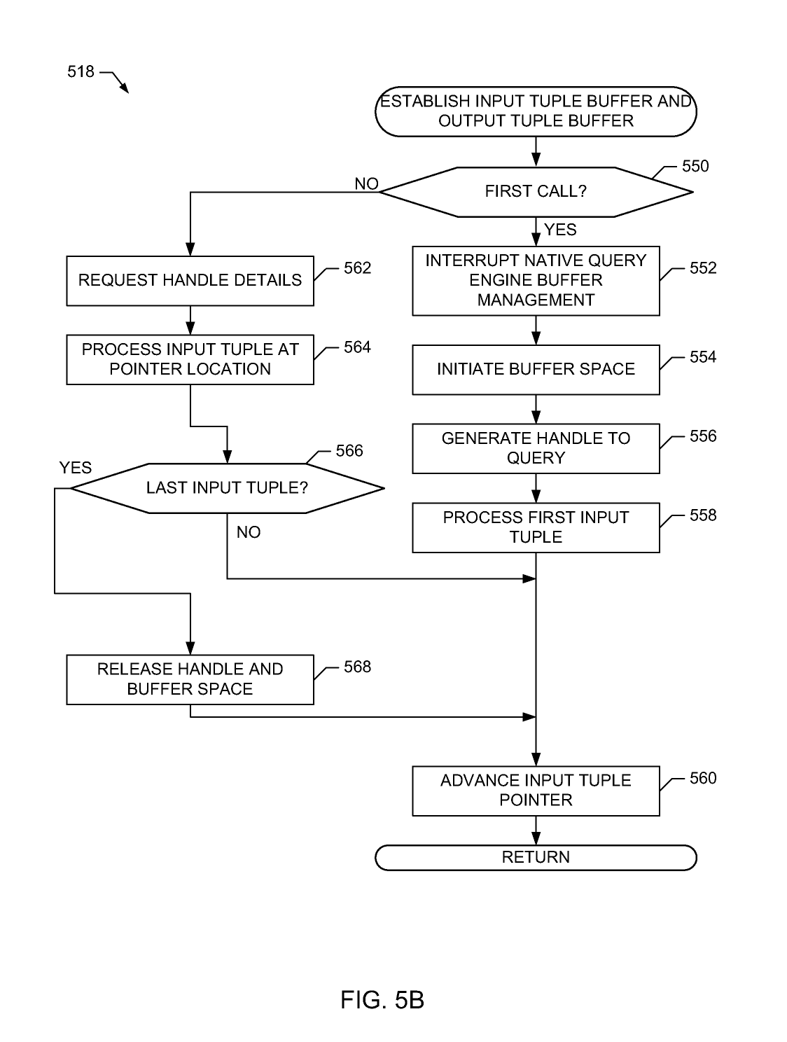

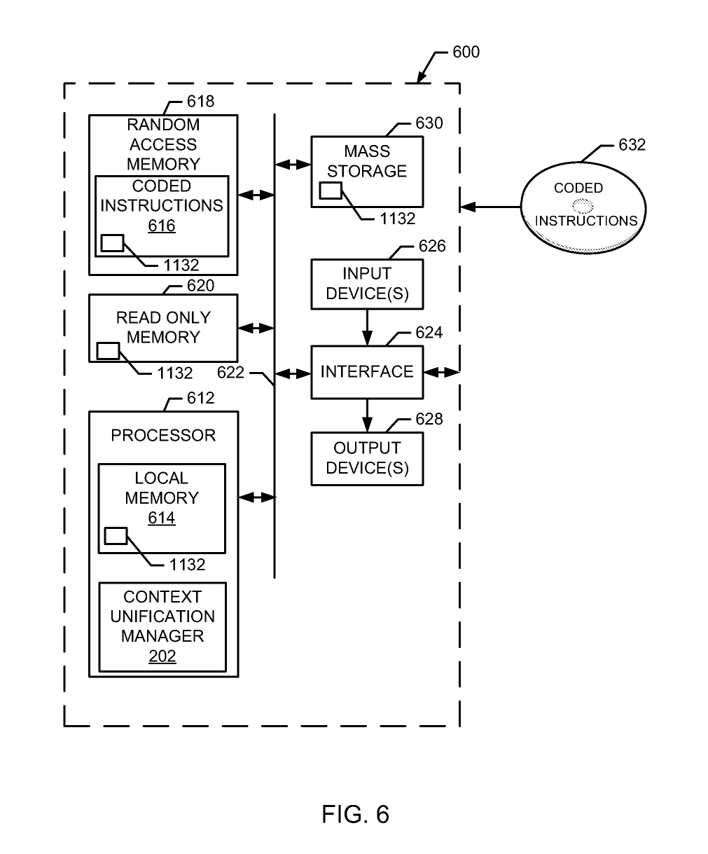

Flowcharts representative of example processes that may be executed to implement the example query engine 200, the example context unification manager 202, the example query request monitor 204, the example input tuple analyzer 206, the example output tuple analyzer 208, the example scalar context manager 210, the example table context manager 212, the example hybrid context manager 214, the example native buffers 216, the example per-function buffer 218, the example per-tuple buffer 220 and/or the example per-return buffer 222 are shown in FIGS. 5A and 5B. In this example, the processes represented by the flowchart may be implemented by one or more programs comprising machine readable instructions for execution by a processor, such as the processor 612 shown in the example processing system 600 discussed below in connection with FIG. 6. Alternatively, the entire program or programs and/or portions thereof implementing one or more of the processes represented by the flowcharts of FIGS. 5A and 5B could be executed by a device other than the processor 612 (e.g., such as a controller and/or any other suitable device) and/or embodied in firmware or dedicated hardware (e.g., implemented by an ASIC, a PLD, an FPLD, discrete logic, etc.). Also, one or more of the processes represented by the flowcharts of FIGS. 5A and 5B, or one or more portion(s) thereof, may be implemented manually. Further, although the example processes are described with reference to the flowcharts illustrated in FIGS. 5A and 5B, many other techniques for implementing the example methods and apparatus described herein may alternatively be used. For example, with reference to the flowcharts illustrated in FIGS. 5A and 5B, the order of execution of the blocks may be changed, and/or some of the blocks described may be changed, eliminated, combined and/or subdivided into multiple blocks.

As mentioned above, the example processes of FIGS. 5A and 5B may be implemented using coded instructions (e.g., computer readable instructions) stored on a tangible computer readable medium such as a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 5A and 5B may be implemented using coded instructions (e.g., computer readable instructions) stored on a non-transitory computer readable medium, such as a flash memory, a ROM, a CD, a DVD, a cache, a random-access memory (RAM) and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. Also, as used herein, the terms “computer readable” and “machine readable” are considered equivalent unless indicated otherwise.

An example process 500 that may be executed to implement the unification of call contexts of a query engine 200 of FIGS. 2-4 is represented by the flowchart shown in FIG. 5A. The example query request monitor 204 determines whether a query request, such as a UDF query, is received (block 502). If not, the example process 500 continues to wait for a UDF query. Otherwise, the example input tuple analyzer 206 examines the received query instructions to identify whether the query is associated with a single input tuple (block 504). In the event that the query is associated with a single input tuple (block 504), the example output tuple analyzer 208 examines the received query instructions to identify whether the query is associated with a request for a single output tuple (block 506). If so, then the example scalar context manager 210 invokes a scalar memory context by initializing and/or otherwise facilitating the example per-function buffer 218 and the example per-tuple buffer 220 (block 508). The example context unification manager 202 executes the query (e.g., the UDF query) using the native resources of the example query engine 200 (block 510).

In the event that the example output tuple analyzer 208 determines that the requesting query includes more than one output tuple (block 506), then the example table context manager 212 invokes a native table memory context by initializing and/or otherwise facilitating the example per-tuple buffer 220 and the example per-return buffer 222 (block 512). The example context unification manager 202 executes the query using the native resources of the example query engine 200 (block 510). On the other hand, in the event that the example input tuple analyzer 206 examines the received query instructions and identifies more than one input tuple (block 504), then the example output tuple analyzer 208 determines whether there are multiple output tuples associated with the query instructions (block 514). If there is a single output tuple associated with the query, but there are multiple input tuples (block 504), then the example scalar context manager 210 invokes a native scalar aggregate memory context by initializing and/or otherwise facilitating the example per-function buffer 218 and the example per-tuple buffer 220 (block 516). However, if there are both multiple input tuples (block 504) and multiple output tuples associated with the query (block 514), then the example hybrid context manager 214 invokes a hybrid context by initializing the example per-function buffer 218, the example per-tuple buffer 220 and the per-return buffer 222 (block 518).

In the illustrated example of FIG. 5B, an example manner of establishing the input buffer and output tuple buffer (block 518) is described. In the event the query is invoking a particular hybrid UDF for the first time (block 550), then the context unification manager 202 interrupts one or more attempts by the query engine (e.g., a legacy query engine 102) to break up the query into separate UDFs and/or transfer query information and/or input tuples to one or more processing applications 116, 118 (block 552). However, if the query engine includes the example context unification manager 202 as a native part of itself, such as the example query engine 200 of FIG. 2, then block 552 may not be needed. The example hybrid context manager 214 initiates buffer space for the hybrid query containing multiple input tuples and multiple output tuples (block 554). Buffer space initiation may include allocating memory space in the buffer 216 for the multiple input tuples, the multiple output tuples, and allowing such allocated memory to persist during the entirety of the hybrid query. In some examples, the hybrid context manager 214 may allocate the example per-function buffer 218, the example per-tuple buffer 220 and/or the example per-return buffer 222.

To allow the example context unification manager 202 to track the status of active memory context configurations, the example hybrid context manager 214 generates one or more handles associated with the hybrid query and/or the allocated buffer(s) 216 (block 556). The query engine processes the first input tuple (block 558) and advances an input tuple pointer to allow for end-of-tuple identification during one or more subsequent calls to the hybrid UDF (block 560).

In the event that the hybrid UDF is not called for the first time (block 550) (which may be determined by performing one or more handle lookup function(s)), the example context unification manager 202 requests memory context details by referencing the handle (block 562). Example details revealed via a handle lookup include additional handles to pointers to one or more allocated memory locations in the buffer 216. The example hybrid context manager 214 references the next input tuple using the pointer location (block 564), and determines whether there are remaining input tuples to be processed in the query (block 566). If so, then the input tuple pointer is advanced (block 560), otherwise the handle and buffer 216, including one or more sub partitions of the buffer (e.g., per-function buffer 218, etc.) are released (block 568).

FIG. 6 is a block diagram of an example implementation 600 of the system of FIG. 2. The example system 600 can be, for example, a server, a personal computer, or any other type of computing device.

The system 600 of the instant example includes a processor 612 such as a general purpose programmable processor. The processor 612 includes a local memory 614, and executes coded instructions 616 present in the local memory 614 and/or in another memory device to implement, for example, the query request monitor 204, the input tuple analyzer 206, the output tuple analyzer 208, the scalar context manager 210, the table context manager 212, the hybrid context manager 214, the per-function buffer 218, the per-tuple buffer 220 and/or the per-return buffer 222 of FIG. 2. The processor 612 may execute, among other things, machine readable instructions to implement the processes represented in FIGS. 5A and 5B. The processor 612 may be any type of processing unit, such as one or more microprocessors, one or more microcontrollers, etc.

The processor 612 of the illustrated example is in communication with a main memory including a volatile memory 618 and a non-volatile memory 620 via a bus 622. The volatile memory 618 may be implemented by Static Random Access Memory (SRAM), Synchronous Dynamic Random Access Memory (SDRAM), Dynamic Random Access Memory (DRAM), Double-Data Rate DRAM (such as DDR2 or DDR3), RAMBUS Dynamic Random Access Memory (RDRAM) and/or any other type of random access memory device. The non-volatile memory 620 may be implemented by flash memory and/or any other desired type of memory device. Access to the main memory 618, 620 may be controlled by a memory controller.

The processing system 600 also includes an interface circuit 624. The interface circuit 624 may be implemented by any type of interface standard, such as an Ethernet interface, a Peripheral Component Interconnect Express (PCIe), a universal serial bus (USB), and/or any other type of interconnection interface.

One or more input devices 626 are connected to the interface circuit 624. The input device(s) 626 permit a user to enter data and commands into the processor 612. The input device(s) can be implemented by, for example, a keyboard, a mouse, a touchscreen, a track-pad, a trackball, an ISO point and/or a voice recognition system.

One or more output devices 628 are also connected to the interface circuit 624. The output devices 628 can be implemented, for example, by display devices (e.g., a liquid crystal display, a cathode ray tube display (CRT)), by a printer and/or by speakers. The interface circuit 624, thus, includes a graphics driver card.

The interface circuit 624 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The processing system 600 of the illustrated example also includes one or more mass storage devices 630 for storing machine readable instructions and/or data. Examples of such mass storage devices 630 include floppy disk drives, hard drive disks, compact disk drives and digital versatile disk (DVD) drives. In some examples, the mass storage device 630 implements the buffer 216, the per-function buffer 218, the per-tuple buffer 220 and/or the per-return buffer 222 of FIGS. 2 and 3. Additionally or alternatively, in some examples, the volatile memory 618 implements the buffer 216, the per-function buffer 218, the per-tuple buffer 220 and/or the per-return buffer 222 of FIGS. 2 and 3.

The coded instructions 632 implementing one or more of the processes of FIGS. 5A and 5B may be stored in the mass storage device 630, in the volatile memory 618, in the non-volatile memory 620, in the local memory 614 and/or on a removable storage medium, such as a CD or DVD 632.

As an alternative to implementing the methods and/or apparatus described herein in a system such as the processing system of FIG. 6, the methods and or apparatus described herein may be embedded in a structure such as a processor and/or an ASIC (application specific integrated circuit).

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to execute a user defined function (UDF) in a database query engine, comprising:
identifying two or more input tuples associated with a query;
identifying two or more output tuples associated with the query;
associating the input tuples with a query engine input buffer;
associating the output tuples with a query engine output buffer; and
maintaining a state of the query engine input buffer and the query engine output buffer in response to executing the query in the database query engine to process the input tuples and the output tuples.

2. A method as described in claim 1, wherein the query associated with the plurality of input tuples triggers generation of the plurality of output tuples.

3. A method as described in claim 1, further comprising calling a user defined function (UDF) at a first time in response to executing the query in the database query engine, the UDF call at the first time to process a first one of the plurality of input tuples.

4. A method as described in claim 3, wherein the UDF call initializes the state of the query engine input buffer.

5. A method as described in claim 4, further comprising calling the UDF at a second time when a second one of the plurality of input tuples has not been processed by the query engine.

6. A method as described in claim 5, further comprising updating the state of the query engine input buffer in response to processing the second one of the input tuples.

7. A method as described in claim 6, wherein updating the state of the query engine further comprises advancing a tuple pointer associated with the plurality of input tuples.

8. A method as described in claim 4, further comprising releasing the state of the query engine input buffer in response to processing a last one of the plurality of input tuples.

9. A method as described in claim 1, further comprising interrupting an external processing application in response to detecting two or more input tuples and two or more output tuples associated with the query.

10. A method as described in claim 1, wherein the query engine input buffer comprises a per-function memory state maintained for the database query duration.

11. A method as described in claim 1, wherein the query engine output buffer comprises a per-return memory state maintained for the database query duration.

12. A memory context unification manager, comprising:
an input tuple analyzer to identify a database query comprising a plurality of input tuples;
an output tuple analyzer to identify a plurality of output tuples associated with the database query; and
a hybrid context manager to associate the plurality of input tuples and the plurality of output tuples with a persistent query buffer to maintain a buffer state for a duration in which the database query is processed.

13. A memory context unification manager as described in claim 12, wherein the hybrid context manager establishes a per-function buffer memory state associated with the plurality of input tuples and a user defined function invoked by a query engine, the per-function buffer memory state to be maintained for the database query duration.

14. A memory context unification manager as described in claim 13, wherein the hybrid context manager establishes a per-return buffer memory state associated with the plurality of output tuples, the per-return buffer memory state and the per-function buffer memory state to be maintained throughout the database query duration.

15. A memory context unification manager as described in claim 12, further comprising a query request monitor to interrupt invocation of an external processing application when each of the input tuples and the output tuples are greater than one.

16. A memory context unification manager as described in claim 12, wherein the hybrid context manager releases the buffer state in response to processing a last one of the plurality of input tuples.

17. A tangible article of manufacture storing machine readable instructions which, when executed, cause a machine to, at least:
identify a number of input tuples associated with a database query;
identify a number of output tuples associated with the database query; and
invoke a persistent buffer memory context in response to identifying the number of input tuples associated with the database query being greater than one and the number of output tuples associated with the database query being greater than one.

18. A tangible article of manufacture as described in claim 17, wherein the machine readable instructions, when executed, further cause the machine to interrupt a native query engine buffer system from invoking an external processing application when each of the number of input tuples and each of the number of output tuples are greater than one.

19. A tangible article of manufacture as described in claim 17, wherein the machine readable instructions, when executed, further cause the machine to generate a pointer associated with the number of input tuples, the pointer to advance through the number of input tuples after the input tuples are processed by the database query.

20. A tangible article of manufacture as described in claim 19, wherein the machine readable instructions, when executed, further cause the machine to release the persistent buffer memory context in response to an indication from the pointer that a last input tuple has been processed by the database query.
